(19) United States
(12) Patent Application Publication
(10) Pub. No.: US 2003/0024192 A1
(43) Pub. Date: Feb. 6, 2003

(54) Three dimensional insulation panel having unique surface for improved performance

(75) Inventor: Jack Spargur, Rancho Mirage, CA (US)

Correspondence Address: NIXON & VANDERHYE P.C., 8th Floor, 1100 North Glebe Road, Arlington, VA, 22201, US

(73) Assignee: Atlas Roofing Corporation

(21) Appl. No.: 10/131,488

(22) Filed: Apr. 25, 2002

Related U.S. Application Data
(63) Continuation-in-part of application No. 09/657,512, filed on Sep. 7, 2000, now abandoned.
(60) Provisional application No. 60/222,925, filed on Aug. 4, 2000.

(51) Int. Cl. B29D 9/00

(52) U.S. Cl. 52/309.4; 264/45.5

(57) ABSTRACT

A shape molding operation is performed to form a three dimensional building panel. The operation involves providing a mold having a cavity, the cavity having dimensions essentially identical to a finished three dimensional building panel suitable for installation. The shape molding operation involves pre-heating at least one of two major internal surfaces of the mold; introducing polystyrene foam beads into the cavity; heating the polystyrene foam beads; and causing the heated polystyrene foam beads to flatten and spread against the pre-heated major internal surface of the mold, thereby forming a sealed water-repellant skin at least on a face of the three dimensional building panel. In view of the corresponding size of the mold cavity, no cutting action is required on the expanded polystyrene (EPS) foam formed therein, so that a least a building-contacting face of the resultant boards acquires the sealed water-repellant skin that is otherwise lost when forming boards from buns of the prior art. The insulated building panel is preferably formed with said building-contacting surface or face of the panel having a regular pattern of either water drainage grooves or raised protrusions. The protrusions can have various shapes, such as a quadrilateral (e.g., diamond, or rhombus) shape, a circular shape, an elliptical shape, or a triangular shape, for example.

### BACKGROUND

This application is a continuation-in-part of U.S. patent application Ser. No. 09657,512 filed Sep. 7, 2000, which in turn claims the priority and benefit of U.S. Provisional Patent Application Serial No. 60/222,925, filed Aug. 4, 2000, both of which are incorporated herein by reference in their entirety.

I. Field of the Invention

The present invention pertains to a three dimensional expanded polystyrene foam insulation board or panel, and particularly to such insulation board which is resistant to moisture penetration.

II. Related Art and Other Considerations

Building materials with moisture drainage capabilities have been known in the construction industry for many years, for example in connection with fabricated water drainage systems for subterranean walls. In this regard, see U.S. Pat. Nos. 3,563,038, 3,654,765, and 4,490,072. Eventually some such materials also included insulating capabilities to provide added value. One system, disclosed in U.S. Pat. No. 4,318,258, provided for shrinkage and air circulation in two dimensions, in addition to drainage and insulation. Other systems where insulation and drainage provisions occur together include those found in U.S. Pat. Nos. 3,561,177, 4,309,855, 4,467,580; 4,730,953; 5,016,415; 5,056,281; 5,218,798; 5,410,852; 5,511,346; 5,615,525; 5,860,259; 5,979,131.

Styrofoam® is made by a plastic extrusion process, and was the first of family of products which became known as “Extruded Polystrene” (XPS) foam. The plastic extrusion process used for Styrofoam® creates adjacent cells without porous channels between them. It is well known that Dow's Styrofoam® is water-impermeable. In fact, while (with some specially processing) other forms of polystyrene can be made “water-repellant” to some degree, XPS is the only form of polystyrene foam that can claim the title “water-impermeable”.

Most of the prior-art and current drainage systems use a form of grooving technology, but grooved only in the vertical direction. In the product information pamphlet entitled, “Styrofoam® Stuccomate®” (Form No. 179-7995-798QRP), reference is made to “. . . vertical channels spaced inches on center . . . pressed into the inside or backside face of the boards to help manage moisture movement . . . . ” The Stuccomate® pamphlet statement that “. . . vertical channels . . . (are) . . . pressed into the . . . face of the boards . . . ” is also mentioned in U.S. Pat. No. 4,309,855, which refers to “embossing a plurality of raised rectangular protuberances” in a “water-impermeable backing plate 20”. The only polystyrene that could be used to make the “water-impermeable backing plate” of U.S. Pat. No. 4,309,855 is “Extruded Polystyrene” (XPS) foam. A secondary, separate process step is required to achieve the vertical channels which are pressed into the face of the boards. Likewise, a separate process step is needed to emboss the plurality of raised rectangular protuberances in the water-impermeable backing plate. These extra process steps in both cases add substantially more cost.

There is a potential physical drawback to XPS. In buildings that contain warm moist air, when the outside temperature is lower than inside, XPS can trap condensed water inside the wall cavity where glass fiber and rock wool batt insulations can become wet with water, reducing insulation value.

In recent years, the building industry has increasingly turned to another type of polystyrene foam, i.e., “Expanded Polystyrene” (EPS) foam. Advantageously, EPS (Expanded) foam is less expensive than just about any XPS (Extruded) foam, whether compared by cost per weight or cost per volume. In contrast to XPS foam, Expanded Polystyrene foam (EPS) does absorb water. However, when formed in an essentially smooth hot mold, a water-repellent property can be afforded to an expanded polystyrene (EPS) foam surface.

As an example of what is meant by “water-repellant”, a conventional white EPS drinking cup, filled with any hot or cold liquid drink for several days, initially holds the liquid but usually, somewhere between 24 and 72 hours, permeates some beads of fluid to the outside surface. Such example illustrates that expanded polystyrene (EPS) foam is not “water-impermeable” as is extruded polystyrene form (XPS), but when formed against a hot mold, expanded polystyrene (EPS) foam becomes “water-repellant”.

In many cases the ability of expanded polystyrene (EPS) foam to allow moist air to pass through it is a considerable advantage. For example, U.S. Pat. No. 5,410,852 discloses a permeable insulation. The ability of EPS to “breathe” is becoming more popular with architects and builders. Besides offering improved humid air permeation, EPS provides a significant cost advantage when compared to XPS.

Heretofore the EPS used for building insulation has been restricted to insulation boards that are cut from large “buns” in a block molding process. In the block molding process, large three-dimensional buns are usually created (having dimensions, e.g., 32-inches by 4-feet by 16-feet). The buns (such as bun 800 shown in FIG. 8) are formed in large molds. Typically the molds have radiused corners, so that corresponding corners of the buns are rounded. When extracted from the mold, the surfaces of the buns have a bulge due to internal pressure in the buns. As depicted by dotted lines in FIG. 8, these buns are then cut into boards 804 (of which, for simplicity, only three such boards are shown in FIG. 8, although typically many more such boards are cut). The cutting process can be implemented by techniques such as hot-wire cutting or by machining. Further, the cutting process can involve (depending on the size of the bun and desired size of the resultant boards) a two step cutting procedure, with a first aspect of the cutting procedure providing a cut in a first direction (comparable to the horizontal cut dotted lines in FIG. 8) and a second aspect of the cutting procedure providing a cut in a second direction (comparable to the vertical cut dotted lines in FIG. 8). In the cutting process, between 0.5 inch and 1.0 inch is essentially shaved off each surface of the bun to eliminate the effects of the bulges and the rounded corners. In so doing, any water-repellant sealed skin which may have been formed on the bun is eliminated. Typically, for a bun having a 32-inch dimension, the 32-inch dimension of the bun is sliced into boards 804 which are 1- to 2-inch thick and are 4-feet by 8- or 16-feet for their other dimensions.

The cutting or slicing of the boards from the bun (e.g., along the broken lines illustrated in FIG. 8) leaves the resultant boards with a surface texture that is rough and comprised of a great number of open pores. These open passageways quickly absorb water. Consequentially, the rough surfaces of these boards have been shown to absorb and hold large amounts of water instead of allowing water to drain properly. While the original bun may have had a sealed skin, the sealed skin has been eliminated by the cutting process, leaving the boards with surfaces that are not sealed and thus not water-repellant.

Many wall insulation systems using either EPS or XPS employ vertical slots for water drainage. Some of those systems that have also added horizontal venting have used rectangular shapes to produce the venting area. For example, U.S. Pat. No. 4,318,258 shows rectangles as the preferred method of creating the desired venting area. However, when a flat edge of such a rectangle is placed horizontally thereby forming a ledge, the rectangle will hold an appreciable amount of water. Horizontal ledges, such as found on horizontally-oriented squares and rectangles, may hold enough water to fail the building industry's water drainage test. With modem standards mandating fast and complete water drainage, horizontal ledges are undesirable.

What is needed therefore, and an object of the present invention, is a simplified, considerably lower-cost insulating system comprising a expanded polystyrene (EPS) foam insulation drainage board which provides adequate water drainage (e.g., provides adequate resistance to water encroachment).

An advantage of the present invention is avoidance of the extra cost of needing XPS to gain water-impermeability. Further, the present invention advantageously avoids the extra cost of a second embossing process step to gain water drainage channels or raised protuberances.

### BRIEF SUMMARY

A shape molding operation is performed to form a three dimensional building panel. The operation involves providing a mold having a cavity, the cavity having dimensions essentially identical to a finished three dimensional building panel suitable for installation. The shape molding operation involves pre-heating at least one of two major internal surfaces of the mold; introducing polystyrene foam beads into the cavity; heating the polystyrene foam beads; and causing the heated polystyrene foam beads to flatten and spread against the pre-heated major internal surface of the mold, thereby forming a sealed water-repellant skin at least on a face of the three dimensional building panel. In view of the corresponding size of the mold cavity, no cutting action is required on the expanded polystyrene (EPS) foam formed therein, so that a least a building-contacting face of the resultant boards acquires the sealed water-repellant skin (that is otherwise lost when forming boards from buns of the prior art).

In view of the fact that the cavity has dimensions essentially identical to a finished three dimensional building panel suitable for installation, a first dimension of the mold cavity is between one inch and two inch inclusive. For example, the first dimension of the mold cavity can be, e.g., 1.0 inch; 1.5 inch; and 2.0 inch.

In accordance with the process, the board formed in the mold has the sealed water-repellant skin formed on all its faces. The board is installed with at least one face, e.g., a building-contacting face, and preferably all faces, retaining the sealed water-repellant skin.

In one of its aspects, the shape molding operation involves using the pre-heated major internal surface of the mold to form multiple drainage channels grooved into a main plane of the face of the three dimensional building panel that has the sealed water-repellant skin. From an alternative perspective, the pre-heated major internal surface of the mold is used to form multiple discrete islands raised above a main plane of the face of the three dimensional building panel that has the sealed water-repellant skin. Thus, in some embodiments the three dimensional expanded polystyrene building panel has at least its building-contacting face formed with a sealed, water-repellent skin to retard moisture encroachment, thereby providing an improved surface for faster water drainage, and which becomes dry quickly after becoming wet. The smooth skin surface can have a majority of the panel face area comprised of quadrilateral (e.g., diamond) shaped areas having drainage channels between them; or conversely, a plurality of discrete protrusions or islands can be raised above a majority plane of the panel face.

In one of its aspects, the expanded polystyrene (EPS) foam insulation drainage board a surface area comprised mostly of quadrilateral shapes with a minor portion of the surface area comprised of channels, or grooves, in between the quadrilateral shapes. The channels are used for water drainage while the shapes make contact with the wall of the building. The shapes can be called “protrusions”, or “raised islands”, or “protuberances”, and imply that these shapes comprise the minority of surface area that rises above the major surface area of the lower plane. The protrusions can have various shapes, such as a quadrilateral (e.g., diamond, or rhombus) shape, a circular shape, an elliptical shape, or a triangular shape, for example.

The multiple discrete protrusions create a spacing of the channels from the building when installed, allowing the drainage channels to quickly drain water. The sizes and the shapes of the protrusions create channels that facilitate water drainage and provide for air circulation in both horizontal as well as vertical directions. The protrusions of the panel can also receive a construction adhesive prior to placing the insulation panel against the building's surface (e.g., wall of the building). The installed panel then necessarily leaves a space between the panel and the building.

The protrusions are oriented so that walls of the protrusions, which extend perpendicular to the face, form a surface other than a horizontal shelf when the panel is installed and contacting the building.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is plan view of an example building panel according to a first embodiment of the invention.

FIG. 2 is a 3-dimensional view of the building panel of FIG. 1.

FIG. 3 is a side view of the building panel of FIG. 1.

FIG. 4 is an end view of the building panel of FIG. 1.

FIG. 5 is a plan view of an example building panel according to a second and a preferred embodiment of the invention.

FIG. 6 is a plan view of an example building panel according to a third embodiment of the invention.

FIG. 7 is a plan view of an example building panel according to a fourth embodiment of the invention.

FIG. 8 is a plan view of a bun of expanded polystyrene (EPS) foam produced by prior art methods from which insulation boards are formed in a cutting process.

FIG. 9 is a cross-sectional view of a shape molding system employed to produce an expanded polystyrene (EPS) foam insulation drainage board with sealed water-repellant skin. FIG. 9A is a sectioned view, taken along line 9A-9A of FIG. 9, showing e.g., a major surface of a male mold member of the shape molding system of FIG. 9.

FIG. 9B is a sectioned view, taken along line 9B-9B of FIG. 9, showing, e.g., a major surface of a female mold member of the shape molding system of FIG. 9.

FIG. 9C is a schematic view of a molding system having two or more instances of the structure shown in FIG. 9.

FIG. 10 is a flowchart showing basic example steps involved in a shape molding operation for producing an expanded polystyrene (EPS) foam insulation drainage board.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known structures and methods are omitted so as not to obscure the description of the present invention with unnecessary detail.

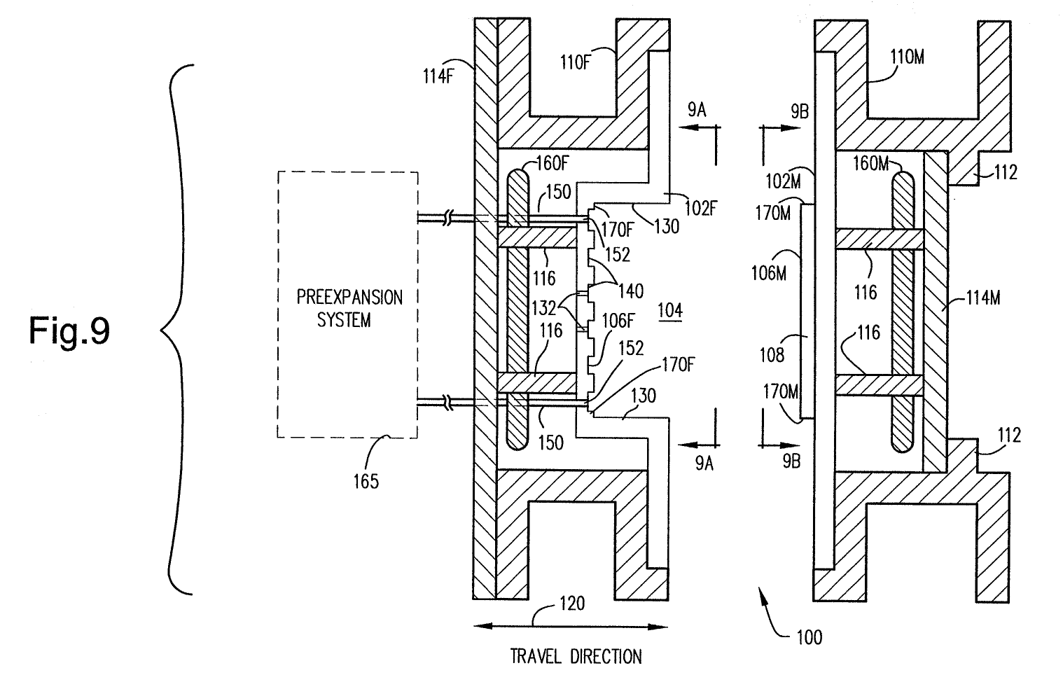

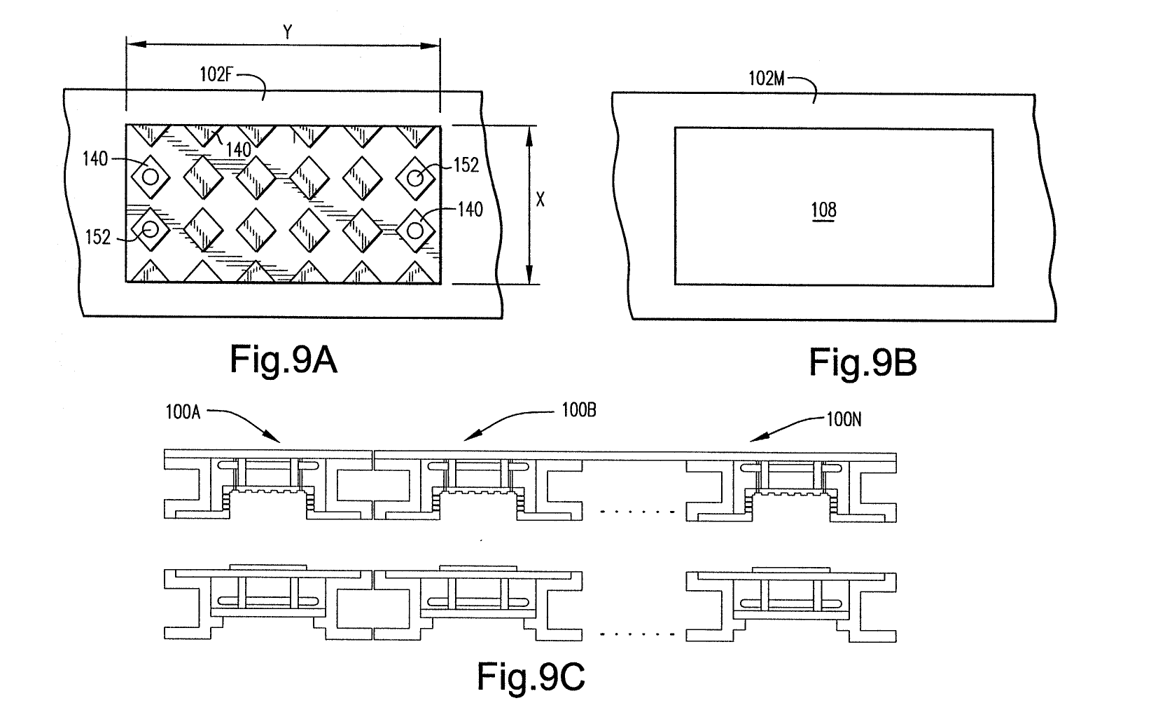

Described herein are, e.g., shape molding methods for producing three dimensional expanded polystyrene (EPS) foam boards that have sealed water-resistant skins, and the insulation boards resulting from such methods. The shape molding operation employs apparatus such as that shown in FIG. 9.

FIG. 9 shows an example, non-limiting, illustrative shape molding system 100 for forming a three dimensional building panel. The system includes a mold comprising male mold member or plate 102M and female mold member or plate 102F, which when mated together form a mold cavity 104. The mold cavity 104 has dimensions essentially identical to a finished three dimensional building panel suitable for installation. In an example embodiment, the mold members 102M, 102F can be made of stainless steel, or may be made of aluminum having a fluoropolymer (Teflon®-type) coating, or any such similar suitable material can be used. The mold members 102M, 102F have respective major opposed internal surfaces 106M, 106F. The major surface 106M of the male mold member 102M may comprise a cavity-facing surface of a crackplate 108 which is mounted on male mold member 102M. A thickness of the crackplate 108 is chosen in accordance with a desired thickness of the finished three dimensional building panel. For example, differing sizes (thicknesses) of interchangeable crackplates 108 can be utilized, such as a first crackplate used to form a one inch thick building panel; a second crackplate used to form a one and one-half inch building panel; and a third crackplate used to form a two inch building panel. A degree of interlock between the male mold member 102M and female mold member 102F corresponds to the thickness of crackplate 108. As shown in FIG. 9B, the major surface 106M of the male mold member 102M, e.g., the surface of crackplate 108, is essentially smooth.

Edges of the male mold member 102M and female mold member 102F are retained in (e.g., mounted to) a steam chest 110. The steam chest 110 includes a male steam chest half 110M which retains male mold member 102M, and a female steam chest half 110F which retains female mold member 102F. The male steam chest half 110M has two opposed shoulders 112 which retain a support plate 114M. A support plate 114F is retained or otherwise secured at the rear of female steam chest half 110F. Bosses 116M extend between support plate 114M and male mold member 102M to provide support and reinforcement, with bosses 116M contacting a backside of male mold member 102M in the region of major surface 106M of the male mold member 102M. Similarly, bosses 116F extend between support plate 114F and female mold member 102F to provide support and reinforcement, with bosses 116F contacting a backside of female mold member 102F in the region of major surface 106F of the female mold member 102F.

At least one of male steam chest half 110M and female steam chest half 110F is movable in order to mate the male mold member 102M and female mold member 102F. In the illustrated embodiment, the male steam chest half 110M with the male mold member 102M contained therein is preferably stationary, with female steam chest half 110F and female mold member 102F contained therein being movable in the direction depicted by double-headed arrow 120 in FIG. 9. Mating of male mold member 102M and female mold member 102F forms an essentially closed cavity 104 in which the building panel is formed according to an panel formation operation hereinafter described in more detail. Means for moving female steam chest half 110F (or male steam chest half 110M in a case in which the other half of the mold is moveable) are known to those skilled in the art.

As shown in FIG. 9, the major opposed internal surfaces 106M, 106F of mold members 102M, 102F have steam portals 132 formed therein. The steam portals are placed with centers about 1.25 inches apart, only a few representative steam portals 132 being illustrated in FIG. 9. The steam portals 132, which can also serve as vacuum portals, are connected to an unillustrated value or the like through which selectively steam can be applied to mold cavity 104 or a vacuum pulled in cavity 104. The person skilled in the art appreciates how to implement such a valve including connections to a source of steam and an exhaust manifold (vacuum) or the like.

As shown in both FIG. 9 and FIG. 9A, the major surface 106F of female mold member 102F has feature-forming depressions 140 formed therein. The depressions 140 provided on the major surface 106F of female mold member 102F are situated for forming certain projections on the building panel. The projections (hereinafter described) are suitable for facilitating drainage properties of the building panel.

The shape molding system 100 has means for introducing polystyrene beads into mold cavity 104. In the illustrated embodiment, the means for introducing the polystyrene beads into mold cavity 104 takes the form of fill guns having fill gun barrels 150. In one variation of the illustrated embodiment, the fill gun barrels 150 preferably extend through support plate 114F and female mold member 102F, e.g., are situated on the female steam chest half side of shape molding system 100, and terminate at fill gun barrel orifices 152 formed (as shown in FIG. 9 and FIG. 9A) in depressions 140 of major surface 106 of female mold member 102F.

In one variation of the example mode, the polystyrene foam beads injected into mold cavity 104 are preferably pre-expanded polystyrene beads. To this end, an optional pre-expansion system 156 is illustrated in FIG. 9 as feeding the fill gun barrels 150. The pre-expansion system 156 includes a pre-expander which uses stream and an agitator to pre-expand the polystyrene foam beads. The pre-expanded polystyrene beads are stored in large bags or silos which comprise the pre-expansion system 156 in order to give the pre-expanded polystyrene beads time to gas out and stabilize. When needed for the shape molding operation, the pre-expanded polystyrene beads are transported via blowers comprising the pre-expansion system 156 to a hopper of the shape molding system 100. The pre-expanded polystyrene beads are then injected into the mold cavity 104 from the hopper via the fill gun barrels 150. The pre-expanded polystyrene beads are all approximately the same size at the time the pre-expanded polystyrene beads enter mold cavity 104.

The shape molding system 100 further comprises cooling coils 160M and 160F which are situated within male steam chest half 110M and female steam chest half 110F, respectively. In the illustrated embodiment, the cooling coils 160 are situated between the mold member and the support plate 114 in the respective steam chest half.

As indicated above, the mold cavity 104 has dimensions essentially identical to a finished three dimensional building panel suitable for installation. In an example, non-limiting embodiment, the female mold member 102F and male mold member 102M are sized in order to produce a expanded polystyrene (EPS) foam insulation drainage board which has a first dimension (illustrated by arrow X in FIG. 9A) on the order of twenty four inches, and a second dimension (illustrated by arrow Y in FIG. 9A) on the order of forty eight inches. Moreover, the male mold member 102M and female mold member 102F are formed with sharp corners 170M, 170F, respectively, so that the resulting building panel formed in mold cavity 104 also has rectangular corners suitable for a full building panel.

The FIG. 9 embodiment of shape molding system 100 shows a mold cavity 104 for formation of a single building panel. It should be understood, however, that an overall shape molding assembly may have several isolated compartments (e.g., cavities) for forming several boards at one time. In other words, an overall shape molding system such as that illustrated in FIG. 9C may have two or more instances of the structure shown in FIG. 9, forming two or more isolated mold cavities, with only one building panel being formed in each mold cavity in order to accord the desired surface properties to the resultant building panels. For example, the shape molding system 100 of FIG. 9C shows a first instance 100A, a second instance 100B, up to an Nth instance 100N, with each instance including its own version of the structure shown in FIG. 9. In one example implementation, N=4. The number of instances is not critical to the present invention; production volume requirements determine mold size and the number of instances (e.g., the number of cavities).

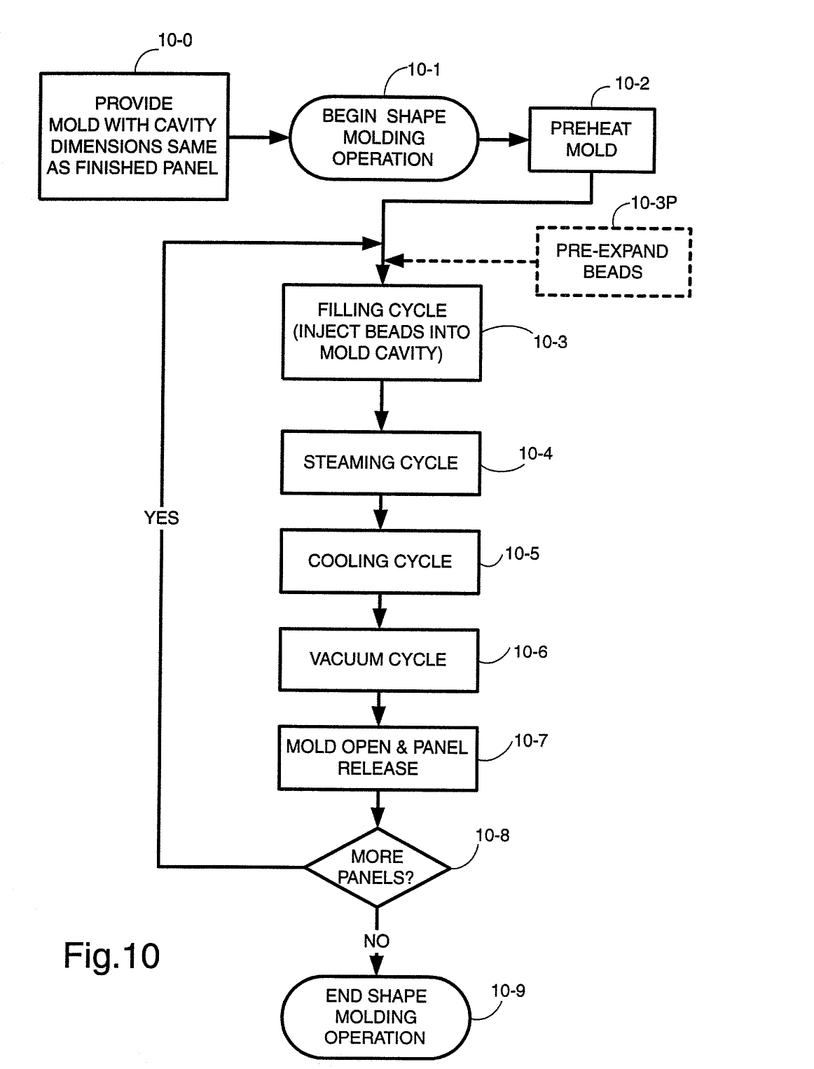

Example, non-limiting steps of a representative mode of the shape molding operation for producing an expanded polystyrene (EPS) foam insulation drainage board are illustrated in flowchart form in FIG. 10. The first step 10-0 involves providing the aforedescribed mold (e.g., of a shape molding system 100 such as that described with respect to FIG. 9) with mold cavity dimensions which are essentially identical to a finished three dimensional building panel suitable for installation.

Step 10-1 of FIG. 10 depicts beginning of the example shape molding operation. Beginning of the shape molding operation includes moving the female mold member 102F toward the male mold member 102M in the direction of arrow 120 (see FIG. 9), thereby forming the mold cavity 104.

Moreover, upon initiation of the shape molding operation, e.g., prior to production of a first expanded polystyrene (EPS) foam insulation drainage board, as step 10-2 the mold is pre-heated. As step 10-2, at least one and preferably both of major internal surfaces of the members which form the mold cavity, e.g., the major surface 106M of male mold member 102M and the major surface 106F of female mold member 102F the male mold member 102M and female mold member 102F, are pre-heated. The preheating of step 10-2 is accomplished by injecting steam into mold cavity 104 through steam portals 132 in the female mold member 102F. At step 10-2 the members which form the mold cavity 104 are preferably heated to a temperature in a range from about 140 degrees Fahrenheit to about 160 degrees Fahrenheit (certainly below 180 degrees Fahrenheit, i.e., the melting temperature of polystyrene. After the pre-heating of step 10-2, the steam subsequently utilized in the shape molding operation maintains the mold temperature, such that further pre-heating should be unnecessary.

The step 10-3 of the shape molding operation of FIG. 3 concerns a filling cycle, which comprises introducing (e.g., injecting) polystyrene foam beads into the mold cavity 104. The polystyrene foam beads are injected into mold cavity 104 through the fill gun barrels 150. In the manner described previously with reference to pre-expansion system 156, the polystyrene foam beads injected into mold cavity 104 may be pre-expanded polystyrene beads. To this end, step 10-3P of FIG. 10 shows an optional step of pre-expanding the polystyrene foam beads to form the pre-expanded polystyrene beads. The optional nature of step 10-3P is depicted by the broken line of the processing symbol for step 10-3P. The pre-expanded polystyrene beads are injected into mold cavity 104 in the manner previously described with reference to pre-expansion system 156.

The quantity of pre-expanded polystyrene beads injected into mold cavity 104 at step 10-3 depends on the desired finished thickness of the expanded polystyrene (EPS) foam insulation drainage board. For a board having a thickness of about one inch, 380 grams of pre-expanded polystyrene beads are utilized. For a board having a thickness of about one and a half inch, 560 grams of pre-expanded polystyrene beads are utilized. For a board having a thickness of about two inches, 720 grams of pre-expanded polystyrene beads are utilized.

In one example mode of the shape molding operation, the raw polystyrene foam beads prior to pre-expansion have diameter of from about 0.85 mm to about 1.18 mm. After pre-expansion (step 10-3P) in pre-expansion system 156, the finished (e.g., pre-expanded) beads have a diameter of about 3 mm, which is a volume increase of about 30%. The raw beads are commercially available, such as polystyrene foam beads marketed as Nova Chemical 33MB, BASF BFL 322, and Huntsman 5340. Preferably these beads contain a blowing agent (such as Pentane) and a fire retardant.

In an example implementation, as step 10-3 the pre-expanded polystyrene beads are injected into mold cavity 104 via the fill gun barrels 150 at an air pressure of about 80 pounds per square inch (psi). The injection of the beads lasts for approximately seven seconds, and is followed by about five seconds of back fill in order to clear the lines of the fill gun barrels 150.

Step 10-4 of the example shape molding operation of FIG. 10 is a steaming cycle. The steaming cycle of step 10-4 involves heating of the polystyrene foam beads in the mold cavity 104, and expansion of the polystyrene foam beads against the hot major surfaces 106 of the respective mold members 102. Expansion of the polystyrene foam beads against the major surfaces 106 of the mold members 102 causes the heated polystyrene foam beads to flatten and spread against the pre-heated major internal surface of the mold, thereby forming a sealed water-repellant skin at least on a face of the three dimensional building panel. The expansion thus causes the polystyrene foam beads to flatten, thereby forming the sealed water-repellant skin on at least one, preferably two, and more preferably all, faces of the building panel.

In one example implementation, the steaming cycle of step 10-4 involves two subcycles of cross-steam injection, followed by a fusion subcycle during which steam continues to flow. During the cross steaming process, steam flows from steam portals 132 formed in the major opposed internal surfaces 106M, 106F of mold members 102M, 102F. Each subcycle of cross-steam injection preferably lasts from about one or two to about five seconds, while the fusion subcycle last for about eight seconds. In the steaming cycle, the temperature in mold cavity 104 is preferably in a range from about 140 degrees Fahrenheit to 160 degrees Fahrenheit.

Step 10-5 of the shape molding operation of FIG. 10 shows a cooling cycle. In the cooling cycle of step 10-5, water is sprayed from cooling coils 160 onto the exterior of both male mold member 102M and female mold member 102F. A stationary stage of the spray lasts for approximately two seconds, which is followed by a moving stage of the spray which lasts approximately another two seconds. The cooling coils 160 in essence serve as a sprinkler system for the mold members.

Step 10-6 of the shape molding operation of FIG. 10 is a vacuum cycle. In the vacuum cycle of step 10-6, a vacuum is pulled through mold cavity 104 and the building panel being formed therein. The application of the vacuum at step 10-6 serves to remove moisture and further cool the building panel being formed, thereby insuring dimensional stability of the building panel being formed in mold cavity 104. The vacuum can be applied through ports such as steam portals 132 (when connected to a vacuum/exhaust) or other comparable ports formed in the mold members, and in an example implementation lasts for approximately twenty eight seconds.

As step 10-7, the mold is open and the building panel being formed therein is released (e.g., the building panel drops out). In the illustrated embodiment of FIG. 9, opening of the mold involves moving the female mold member 102F away from male mold member 102M in the direction of arrow 120. In an example implementation, the mold opening and release of step 10-7 requires about four seconds.

If additional expanded polystyrene (EPS) foam insulation drainage board are yet to be produced, another overall cycle of the shape molding operation is performed by returning to step 10-3. If the last building panel or expanded polystyrene (EPS) foam insulation drainage board has been produced (e.g., if the production run is over), the shape molding operation terminates as indicated by step 10-9. The overall cycle of the shape molding operation from step 10-3 through and including step 10-7 requires about 75 seconds per board (e.g., per iteration).

In one example mode, the step of heating the polystyrene foam beads and the step of causing the heated polystyrene foam beads to flatten and spread against the pre-heated major internal surface of the mold are implemented by introducing steam into the cavity. The steam does two things; it makes the mold surface very hot and it causes the beads to adhere to each other as well as to further expand and conform to the shape of the mold.

In view of the corresponding size of the mold cavity, no cutting action is required on the expanded polystyrene (EPS) foam formed therein, so the face of the resultant boards acquires the sealed water-repellant skin that otherwise is lost when forming boards from buns of the prior art.

The expanded polystyrene (EPS) foam insulation drainage board produced by the shape molding operation such as that typified by the steps of FIG. 10 in the shape molding system 100 of FIG. 9 has the sealed water-repellant skin formed on all its faces. The board is installed with at least one face, e.g., a building-contacting face, and preferably all faces, retaining the sealed water-repellant skin.

As explained above, the expanded polystyrene (EPS) foam insulation drainage boards formed using the shape molding operation are not sliced from a large bun, rather the entire panel (e.g., board) is formed by steam heating polystyrene foam beads pressing against the smooth surface of a hot mold. A contiguous (sealed) skin of polystyrene plastic forms wherever the hot mold contacts the polystyrene. Each board of this invention has at least one broad surface (e.g., the building-contacting face) that was steam molded against the pre-heated smooth surface of a mold. Moreover, as explained subsequently, as one of its aspects the building-contacting faces of the expanded polystyrene (EPS) foam insulation drainage boards can additionally have either multiple raised protrusions or multiple channels. The surface textures of the protrusions, the channels, their edges, and the main broad plane are sealed plastic having substantially no open pores nor passageways. The surfaces are comprised of the smooth, sealed skin of plastic that repels water.

In the preferred method of production, all shapes and dimensions of one expanded polystyrene (EPS) foam insulation drainage board are formed in one mold. Upon leaving the mold, the expanded polystyrene (EPS) foam insulation drainage board has a water-repellent skin on every surface. Preferably one broad face is flat, while the opposite broad face can be comprised of either channels between shaped areas or the protruded shapes.

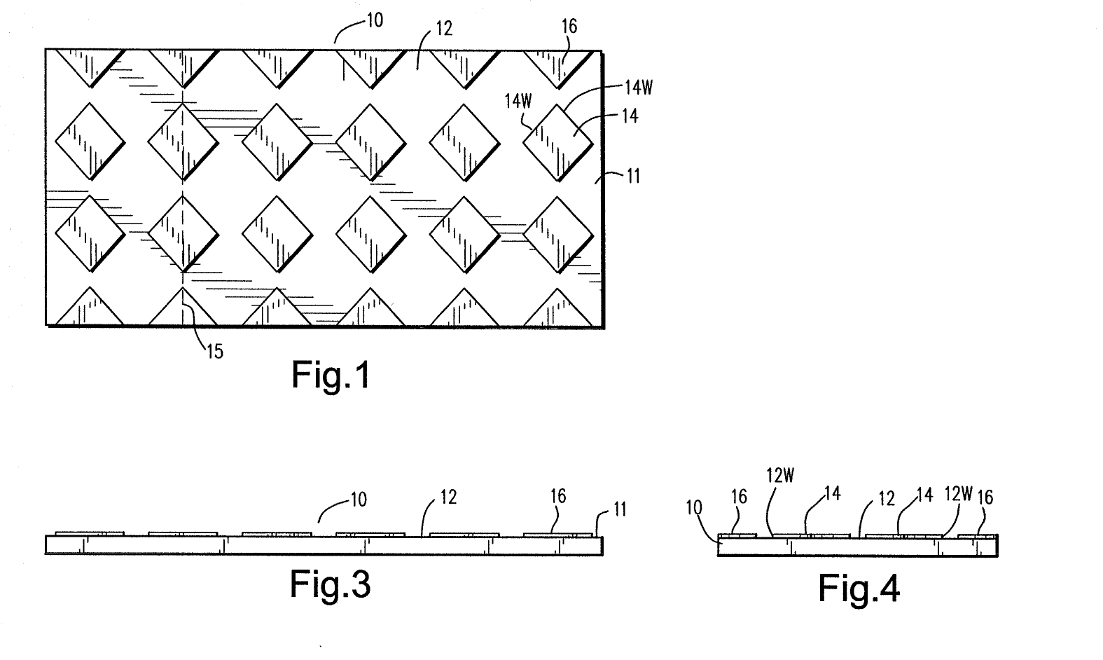

FIG. 1-FIG. 4 show certain aspects of an example building panel 10 formed in accordance with the aforedescribed shape molding process for a expanded polystyrene (EPS) foam insulation drainage board. FIG. 1 particularly shows a broad face or surface 11 of the panel 10 which faces interiorly toward a building when panel 10 is installed. Moreover, broad surface 11 has a regular pattern of protrusions 14 (or raised islands) formed thereon. At least some of the protrusions are, in the illustrated example of FIG. 1, essentially diamond shaped protrusions 14. The protrusions 14 are the features which are fabricated by the depressions 140 provided on the major surface 106F of the female mold member 102 (see FIG. 9 and FIG. 9A) in the shape molding operation.

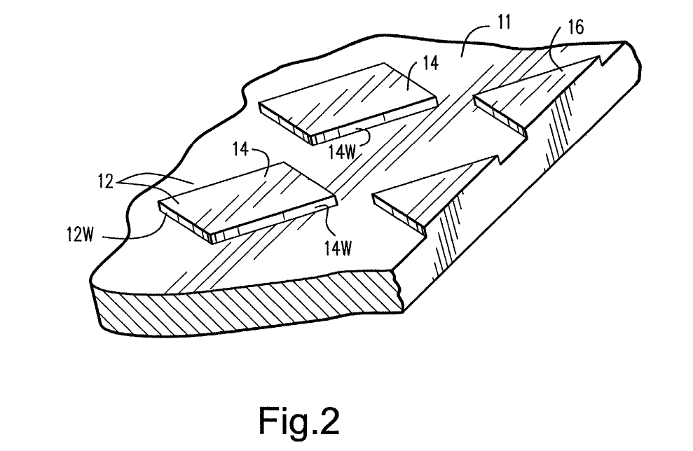

As shown in the three dimensional rendering of FIG. 2, the diamond shaped protrusions 14 have walls 14w which extend essentially perpendicularly from the surface or face 11 of panel 10. As previously explained, the broad surface 11 and the surface of the protrusions 14 as well as their walls 14w are all provided with a water-repellent skin 12 and 12w. The term “diamond shaped protrusion 14” is defined as a shape having a quadrilateral perimeter where none of the sides (walls) are horizontal or vertical when panel 10 is installed. Preferably, but not necessarily, in its installed orientation an uppermost vertex of protrusion 14 and a lowermost vertex of protrusion 14 are vertically aligned along an axis perpendicular to a horizontal edge of panel 10, as indicated by the dashed line 15 in FIG. 1.

Thus, as understood from, e.g., FIG. 1-FIG. 4, when the panel 10 is installed against a building, the walls 14w of protrusions 14 do not form a horizontal shelf. Rather, the walls 14w have an orientation other than a horizontal orientation, such as an angular inclined orientation, for example.

FIG. 1 also shows that the broad surface 11 of the example board 10 also has, around one or more of its perimeter edges, raised protrusions which are primarily triangular in shape, e.g., triangular protrusions 16. Each triangular protrusion 16 is essentially half of the diamond-shaped protrusion 14. These triangular protrusions 16 are used only along any perimeter edge of board 10, and then they are located such that they match another triangular protrusion 16 on the installed adjacent board 10, thus forming a diamond-shaped protrusion 14. The advantage the triangular protrusions 16 provide is a stronger edge when the board 10 is adhered to the building.

While the triangular islands 16 are advantageous for some aspects of the invention as described herein, neither the triangular protrusions 16 nor the diamond-shaped protrusions 14 are essential elements of the present invention. FIG. 3 and FIG. 4 respectively show the side and end views of the panel 10 of FIG. 1.

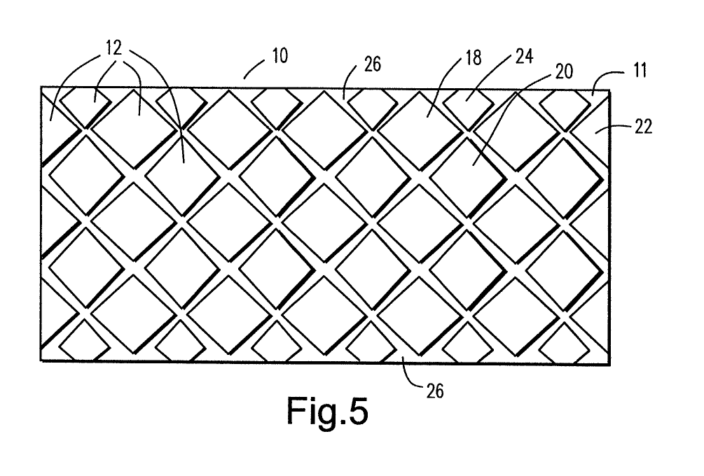

FIG. 5 shows a preferred embodiment of the invention panel 10 having alternating rows of a diamond quadrilateral shape 18 and a rhombus quadrilateral shape 20. All four perimeter edges utilize partial shapes 22 and 24 that match with similar partial shapes on their adjoining panels. In this preferred embodiment, a majority of surface area is comprised of the two quadrilateral shapes 18 and 20, and a minority of area is comprised of drainage grooves (channels) 26 between the shapes. All of this surface area has the water-repellent skin 12 created by the hot mold. The drainage channels 26 are not embossed after manufacturing, but are formed into the face 11 of panel 10 during the one-step manufacturing process of the panel, thus skipping a process step needed in prior art methods. This configuration creates an unusually strong stucco-backing board that still has exceptionally good water drainage properties.

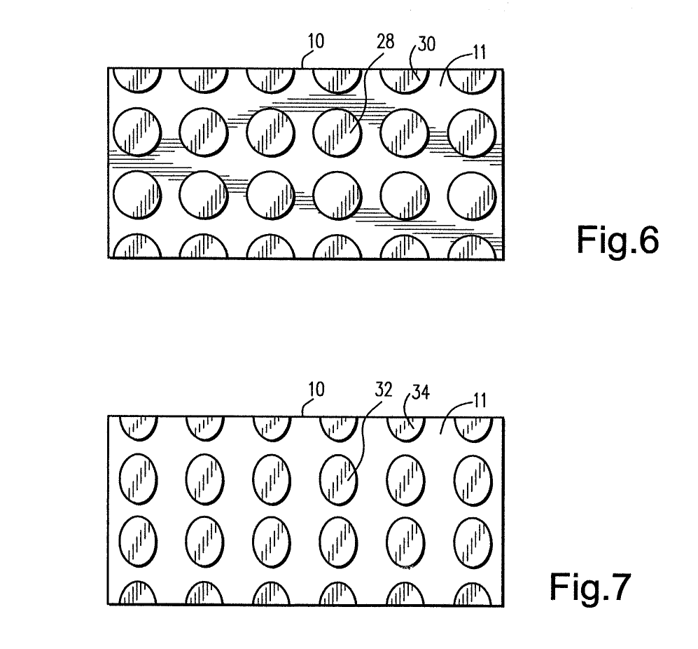

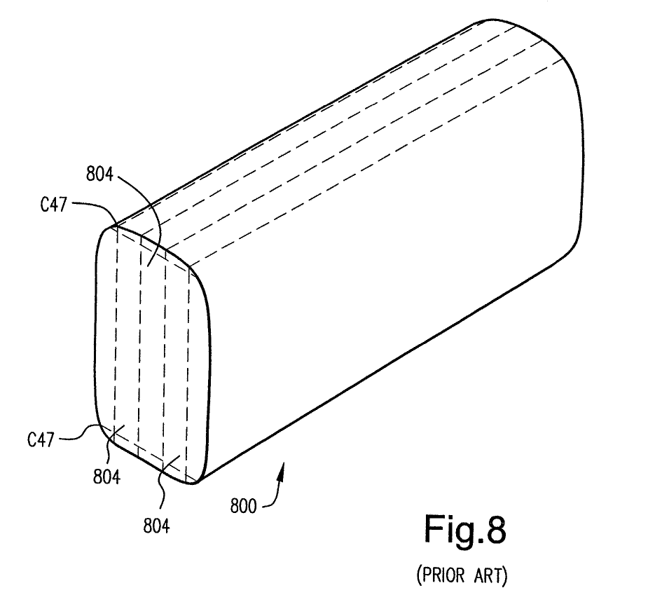

FIG. 6 and FIG. 7 show alternative shapes for the raised protrusions of this invention. FIG. 6 shows full circles 28 and half-circles 30. FIG. 7 shows ellipses 32 and half-ellipses 34. The “half-shapes” match other half-shapes on adjacent panels 10 as described in detail hereinabove. The preferred thicknesses (See FIG. 3 and FIG. 4) of each panel are 1-inch, 1.5-inch, and 2.0-inches. The preferred length and width of individual panels are 48-inches long by 24-inches wide.

At least the building-contacting face 11 of the panel (including the plurality of protrusions) has a smooth, sealed water-repellent skin 12. In other words, face 11 has a unique surface; e.g., one that is steam molded to create a smooth, water-repellent skin such as produced in the expanded polystyrene foam cups made to hold hot or cold liquids. Face 11 is formed by essentially the same steam molding process used to make individual liquid-holding cups from the same EPS raw materials. To reiterate, as described herein the phrase “a sealed water-repellent skin” means a surface identical to the inside surface of a polystyrene hot-or-cold drink cup, or a surface having the properties shown in Table 1, under the heading “Grams Pickup, at Steam-Molded Surface”.

In some cases, however, a smooth skinned surface is not necessarily desirable on the other side of panel 10. For example, most of the stucco exterior systems used today require a rough surface for better adherence of stucco. Hence, for some construction projects, the opposing broad face (e.g., the face opposite face 11) of panel 10 can have a coarse, rough surface to provide better adhesion to any of the many types of stucco exterior finishes. Thus, there can be a smooth skin on one EPS surface which contacts moist air and water, but a rough surface on the opposite EPS face which contacts the exterior stucco coating. So fabricated, buildings using a stucco exterior can have an ideal insulation and ventilation system.

The present invention thus advantageously provides unrestricted flow of air horizontally throughout the whole perimeter of a panel 10. This means moisture-laden air can be removed or dried, thus avoiding water damage from condensation. This advantage in the drying process also increases the overall insulation value of a building.

Thus, all faces (and features of the faces such as all the shapes and grooves) on every expanded polystyrene (EPS) foam insulation drainage board has a water-repellent skin that faces the open channel where water is expected to drain when used in wall construction. It is merely an added feature that the board of the present invention has raised protrusions or indented grooves to insure that an open channel for water drainage exists. Neither the raised protrusions nor their shapes limit the invention.

The building industry's test standard for water drainage efficiency is the “ICBO ES AC 24, Acceptance Criteria for Exterior Insulation and Finish Systems”, dated October 1999. In accordance with this test, water is sprayed through a two-inch by twenty four-inch slot in a wall assembly such that the water goes behind the insulation layer. A calibrated amount of water is applied over a predetermined amount of time. The water is also collected at the bottom of the wall assembly. To PASS the test, a minimum of 90% of the water added must be collected at the bottom. Prior tests have proved that if the applied water contacts rough surfaces of EPS board, it is probable that over 10% of applied water will be absorbed, thus failing the test.

The embodiments of the present invention thus advantageously avoid placing a rough surface where the water must drain, therefore the water drainage efficiency of the newly discovered insulation board exceeds the Condition Of Acceptance (90%), having a rating of 92.5%.

The advantage of providing a smooth surface with a water-repellent skin where the broad face is likely to get wet can be easily understood with reference to the ensuing paragraphs and TABLE 1 below. The water picked up by the rough surface is quickly measurable, whereas the smooth skinned surface showed zero water pick up prior to 1-gram pick up at 120 minutes. The criteria for an EPS water-repellent surface is understood, e.g., with respect to the second column (entitled “Grams Pickup, at Steam-Molded Surface”) of TABLE 1.

There are a number of ways to examine the difference in water resistance between the rough surface of hot-wire cutting, and the smooth, skinned surface of steam molding. Immersion testing can be done using ASTM C 272, ASTM C 1403, or ASTM D 2842. The test method selected was an adaptation of ASTM Test Method D 5795. To hold the water on the EPS surface, PVC plastic pipe coupling pieces were used. These pieces had an inside diameter measuring 4.50-inches. For each test, a silicone adhesive was used to securely fasten the pipe coupling to the EPS surface. The whole assembly with the EPS sample secured to the PVC pipe fitting was weighed. This weight was recorded in a bound notebook. A total amount of 1.75-inches of water was introduced to each sample, and a stopwatch started. Both the smooth skinned surface and the rough cut surface remained in contact with the water for measured times of 15-minutes, 30-minutes, 60-minutes, and 120-minutes. At the end of the predetermined time periods, the water was removed, and the surfaces were blotted dry with paper towel. The assembly was weighed again, with the gram weights duly recorded. Part of the data collected are shown in TABLE 1, which shows a fair representation of the differences expected between the two surfaces tested.

TABLE 1

| | Grams Pickup, at | Grams Pickup, at |
|---|---|---|
| TIME, In Minutes | Steam-Molded Surface | Hot Wire Cut Surface |
| 0 | 0 | 0 |
| 15 | 0 | 2.0 |
| 30 | 0 | 3.0 |
| 60 | 0 | 11.0 |
| 120 | 1.0 | 11* |

The astrisk (*) in Table 1 indicates that, between 60-minutes and 120-minutes the water penetrates the rough cut foam and escapes from the bottom side. Because the water escapes so easily, instead of increasing in weight, the 60-minute pick-up weight of 11-grams remained constant, thus indicating complete saturation.

In a similar but less preferred mode of the shape molding of an expanded polystyrene (EPS) foam insulation drainage board, both broad surfaces of the board are hot molded into water-repellent skins that have either raised protrusions or grooved channels between appropriately shaped areas. In this mode, the panel is essentially produced as a “double-thick” panel, so that it can be sliced into two panels, both having one water-repellent surface and one rough, porous surface. A drawback to this manufacturing mode is that each single panel will curl away from the hot-wire cut surface. Curved panels cannot be utilized. They would need special heat- and stress-relief-treatment to straighten them out enough to use, but that extra step is quite expensive.

For the embodiments herein described, the surfaces of expanded polystyrene (EPS) foam insulation drainage board used in wall construction have water-repellant skin on surfaces that face the open channel where water is expected to drain when used in wall construction. It is merely an added feature that the board of the present invention has raised protrusions or indented grooves to insure that an open channel for water drainage exists. Neither the raised protrusions nor their shapes comprise the invention.

The embodiments of the expanded polystyrene (EPS) foam insulation drainage boards herein described thus advantageously avoid placing a rough surface where the water must drain, therefore the water drainage efficiency of the newly discovered insulation board exceeds the Condition Of Acceptance (90%), having a rating of 92.5%.

The present invention also provides a low-cost insulation system having a sealed skin on an improved surface facing the probable source of water, such that the smooth, sealed skin minimizes water encroachment into the insulation while allowing more water to drain. Further, the vertical surface facing the probable source of water, simply by having a smooth, sealed skin, speeds water drainage from the surface.

Advantageously the present invention provides raised areas of the broad surface facing inwardly, which raised areas are useful for receiving a construction grade adhesive and holding the entire board to the building while leaving an open space between the building and the insulation board. It should be noted that raised surface islands are not necessary in the broadest scope of the invention, because an open space between the insulation boards and the building can be accomplished by using large balls of construction grade adhesive. A modern elastomeric adhesive, applied in large balls (golf-ball sized), can create the necessary spacing between product and building. By providing raised islands, small beads of adhesive can replace large balls of adhesive.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a three dimensional building panel comprising:
(1) providing a mold having a cavity, the mold having two major opposed internal surfaces, the cavity having dimensions essentially identical to a finished three dimensional building panel suitable for installation;
(2) introducing polystyrene foam beads into the cavity;
(3) heating the polystyrene foam beads;
(4) causing the heated polystyrene foam beads to flatten and spread against the pre-heated major internal surface of the mold, thereby forming a sealed water-repellant skin at least on a face of the three dimensional building panel formed by the pre-heated major internal surface of the mold.

2. The method of claim 1, wherein the cavity has a first dimension between and one inch and two inch inclusive.

3. The method of claim 1, wherein the first dimension is one of the following: 1.0 inch; 1.5 inch; and 2.0 inch.

4. The method of claim 1, further comprising pre-heating at least one of the two major internal surfaces of the mold so that the sealed water-repellant skin is formed on at least two faces of the three dimensional building panel formed by two pre-heated major internal surfaces of the mold.

5. The method of claim 1, further comprising pre-heating all internal surfaces of the mold so that the sealed water-repellant skin is formed on all faces of the three dimensional building panel.

6. The method of claim 1, wherein step (4) is facilitated by introducing steam into the cavity.

7. The method of claim 1, wherein step (3) is facilitated by introducing steam into the cavity.

8. The method of claim 1, further comprising as step (2) introducing pre-expanded polystyrene foam beads into the cavity.

9. The method of claim 1, further comprising using the pre-heated major internal surface of the mold to form multiple drainage channels grooved into a main plane of the face of the three dimensional building panel that has the sealed water-repellant skin.

10. The method of claim 9, further comprising using the pre-heated major internal surface of the mold to form multiple discrete islands raised above a main plane of the face of the three dimensional building panel that has the sealed water-repellant skin.

11. The method of claim 1, further comprising producing in the mold a three dimensional building panel having two broad faces and four sides, one of the mold interior surfaces being configured so that a first of the broad faces of the panel has multiple discreet islands raised above a main plane of the first broad face, the multiple discreet islands having at least one island wall which projects from the main plane of the first broad face, no more than one island wall having a wall edge extending parallel to any of the four sides of the panel, and wherein the first broad face including the multiple discreet islands has the sealed, water-resistant skin.

12. The method of claim 11, further comprising configuring the one of the mold interior surfaces so that only islands situated at one of the four sides of the panel have one island wall extending parallel to any of the four sides of the panel.

13. The method of claim 11, further comprising configuring the one of the mold interior surfaces so that a number of the island walls for an island corresponds to a number of sides of a geometrical shape of the island in a plane parallel to the main plane of the first broad face.

14. The method of claim 11, further comprising configuring the one of the mold interior surfaces so that open spaces are provided between islands for facilitating air movement and flow of water by gravity.

15. The method of claim 11, further comprising configuring the one of the mold interior surfaces so that the multiple discrete islands raised above the main plane of the broad surface are circle shaped..

16. The method of claim 11, further comprising configuring the one of the mold interior surfaces so that the multiple discrete islands raised above the main plane of the broad surface are ellipse shaped.

17. The method of claim 11, further comprising configuring the one of the mold interior surfaces so that the multiple discrete islands raised above the main plane of the broad surface are triangle shaped.

18. The method of claim 11, further comprising configuring the one of the mold interior surfaces so that the multiple discrete islands raised above the main plane of the broad surface are diamond shaped.

19. The method of claim 11, further comprising configuring the one of the mold interior surfaces so that walls forming the multiple discrete islands have angles chosen for water drainage efficiency.

20. The method of claim 19, further comprising configuring the one of the mold interior surfaces so that a first axis of the multiple discrete islands is longer than a second axis of the multiple discrete islands..

21. The method of claim 20, wherein the first axis is a vertical axis and the second axis is a horizontal axis.

22. A expanded polystyrene (EPS) foam insulation drainage board produced by the method of claim 1.

23. A expanded polystyrene (EPS) foam insulation drainage board produced by the method of claim 2.

24. A expanded polystyrene (EPS) foam insulation drainage board produced by the method of claim 3.

25. A expanded polystyrene (EPS) foam insulation drainage board produced by the method of claim 4.

26. A expanded polystyrene (EPS) foam insulation drainage board produced by the method of claim 5.

27. A expanded polystyrene (EPS) foam insulation drainage board produced by the method of claim 6.

28. A expanded polystyrene (EPS) foam insulation drainage board produced by the method of claim 7.

29. A expanded polystyrene (EPS) foam insulation drainage board produced by the method of claim 8.

30. A expanded polystyrene (EPS) foam insulation drainage board produced by the method of claim 9.

31. A expanded polystyrene (EPS) foam insulation drainage board produced by the method of claim 10.

32. A expanded polystyrene (EPS) foam insulation drainage board produced by the method of claim 11.

33. A expanded polystyrene (EPS) foam insulation drainage board produced by the method of claim 12.

34. A expanded polystyrene (EPS) foam insulation drainage board produced by the method of claim 13.

35. A expanded polystyrene (EPS) foam insulation drainage board produced by the method of claim 14.

36. A expanded polystyrene (EPS) foam insulation drainage board produced by the method of claim 15.

37. A expanded polystyrene (EPS) foam insulation drainage board produced by the method of claim 16.
